(19) United States
(12) Patent Application Publication
(10) Pub. No.: US 2026/0184387 A1
(43) Pub. Date: Jul. 2, 2026

(54) VEHICLE

(71) Applicant: KAWASAKI MOTORS, LTD., Hyogo (JP)

(72) Inventors: Kota HIDAKA, Akashi-shi (JP); Daisuke SAEKI, Lincoln, NE (US); Lucas KHUBCHANDANI, Lincoln, NE (US)

(73) Assignee: KAWASAKI MOTORS, LTD., Hyogo (JP)

(21) Appl. No.: 19/001,554

(22) Filed: Dec. 26, 2024

(51) Int. Cl. B62D 33/033

(52) U.S. Cl. CPC B62D 33/033

(57) ABSTRACT

A utility vehicle 100 includes: a vehicle body panel 11; and a housing box 5 that includes an opening facing upward and is located adjacent to the vehicle body panel 11. The housing box 5 includes an opening edge portion 51 defining an opening 5a. At least a part of the opening edge portion 51 is separated from the vehicle body panel 11.

### FIELD

The technique disclosed here relates to a vehicle.

### BACKGROUND

U.S. Pat. No. 11,572,110 discloses a vehicle including a housing box detachably attached to a vehicle body panel. The housing box has an opening facing upward. The vehicle body panel has an opening penetrating the vehicle body panel in the thickness direction. The housing box is inserted in the opening of the vehicle body panel to be attached to the vehicle body panel.

### SUMMARY

In the vehicle described above, water such as rainwater flowing along a wall around the opening of the vehicle body panel might enter the housing box.

It is therefore an object of the technique disclosed here to reduce the amount of water entering a housing box.

A vehicle disclosed here includes a vehicle body panel; and a housing box that includes an opening facing upward and is located adjacent to the vehicle body panel, the housing box includes an opening edge portion defining the opening, and at least a part of the opening edge portion is separated from the vehicle body panel.

The vehicle can reduce the amount of water entering the housing box.

### BRIEF DESCRIPTION OF THE DRAWINGS

FIG. 1 is a side view of a utility vehicle as seen from the right.

FIG. 2 is a perspective view of a vehicle rear portion as seen from the right rear.

FIG. 3 is a perspective view of a vehicle body panel, a housing box, and a cargo bed in a cut-off state, as seen from the right rear.

FIG. 4 is a perspective view of the vehicle rear portion from which the housing box is removed, as seen from above.

FIG. 5 is a perspective view of the housing box as seen from obliquely above.

FIG. 6 is a perspective view of the housing box as seen from obliquely below.

FIG. 7 is a cross-sectional view taken along line VII-VII in FIG. 5.

FIG. 8 is a perspective view of the vehicle rear portion as seen from obliquely above.

FIG. 9 is a view of the vehicle body panel, the housing box, and a second support frame taken along a plane orthogonal to the front-rear direction, as seen from the rear.

FIG. 10 is a cross-sectional view of a lower portion of a first side wall and an upper portion of the housing box.

FIG. 11 is a cross-sectional view of a lower portion of a second side wall and the upper portion of the housing box.

FIG. 12 is a cross-sectional view of a lower portion of a third side wall and the upper portion of the housing box.

FIG. 13 is a perspective view of the vehicle rear portion as seen from right below.

FIG. 14 is a perspective view of a bottom plate and the second support frame cut off at a position of a recess in the housing box, as seen from obliquely above.

FIG. 15 is a cross-sectional view of a lower portion of a first side wall and an upper portion of a housing box of a utility vehicle according to a first variation.

FIG. 16 is a cross-sectional view of a lower portion of a first side wall and an upper portion of a housing box of a utility vehicle according to a second variation.

FIG. 17 is a cross-sectional view of a lower portion of a first side wall and an upper portion of a housing box of a utility vehicle according to a third variation.

FIG. 18 is a cross-sectional view of a lower portion of a first side wall and an upper portion of a housing box and describing another method for separating a flange from a lower wall in the top-bottom direction.

FIG. 19 is a side view of a vehicle rear portion as seen from the left.

FIG. 20 is a side view of the vehicle rear portion from which a rear fender is removed, as seen from the left.

### DESCRIPTION OF EMBODIMENTS

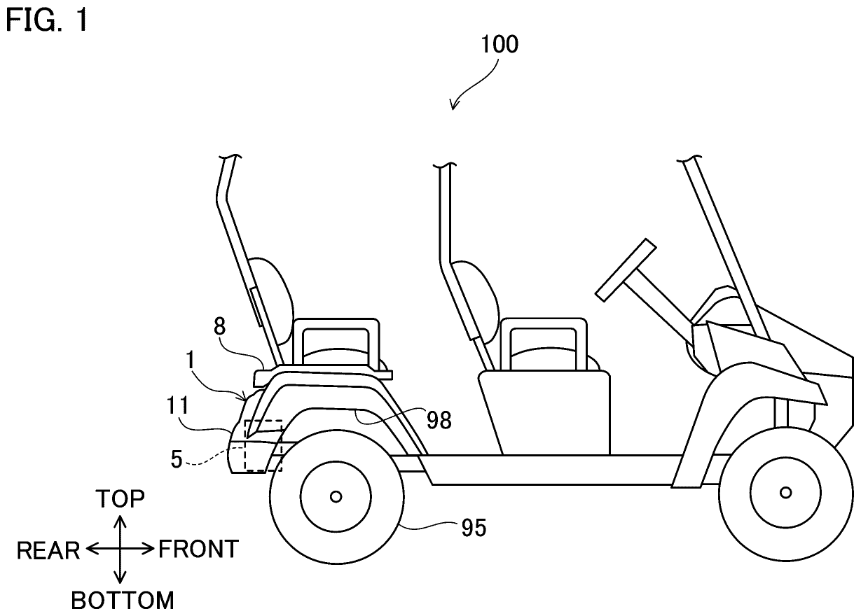

Exemplary embodiments will be described hereinafter with reference to the drawings. FIG. 1 is a side view of a utility vehicle 100 as seen from the right. Hereinafter, the utility vehicle 100 will also be referred to simply as a “vehicle 100.”

The vehicle 100 corresponds to one example of a vehicle disclosed here. The vehicle 100 includes a vehicle intended to travel at low speed in a limited area. Examples of the limited area include a limited community area, a private road, and a private property. Examples of the limited area may include a golf course and a park. The limited community area includes an area available for use by local residents. Examples of the community area include houses and public facilities. The community area includes an area where vehicles not intended to travel on public roads are permitted to travel at low speed. Examples of public facilities include schools and hospitals. The low speed refers to a speed up 20 mph to 30 mph, for example. The vehicle 100 includes, for example, a personal transport vehicle (PTV). The PTV includes a golf cart.

In this disclosure, components of the vehicle 100 will be described based on directions of the vehicle 100. Specifically, “front” refers to the front of the vehicle 100 in the vehicle front-rear directions, and “rear” refers to the rear of the vehicle 100 in the vehicle front-rear directions. “Left” refers to the left of the vehicle 100 when seeing forward, and “right” refers to the right of the vehicle 100 when seeing forward. The “vehicle width directions” refer to the vehicle width directions of the vehicle 100, in other words, means the left-right directions of the vehicle 100 and will be sometimes referred to as “left-right directions.” An “inner side in the vehicle width directions” refers to a cabin side in the vehicle width directions, and an “outer side in the vehicle width directions” refers to a vehicle outer side in the vehicle width directions. The expression “a member extends in a direction” herein includes not only a case where the member extends strictly in parallel with the direction” but also a case where the member extends generally in the direction.” The expression “a member expands in a direction” herein includes not only a case where the member expands strictly in parallel with the direction” but also a case where the member expands generally in the direction.”

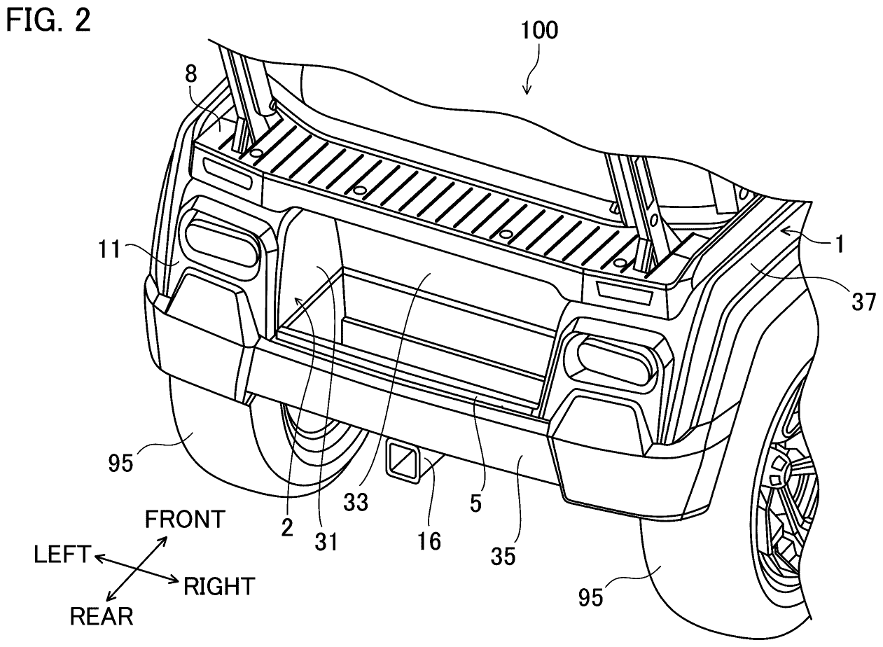

FIG. 2 is a perspective view of a vehicle rear portion as seen from the right rear. The vehicle 100 includes a vehicle body panel 11 and a housing box 5 that includes an opening facing upward and is located adjacent to the vehicle body panel 11. In this embodiment, the housing box 5 is located in a rear portion of a vehicle body 1. The rear portion of the vehicle body 1 will be hereinafter referred to as a “vehicle rear portion.” The vehicle 100 further includes a cargo bed 8 located above the housing box 5.

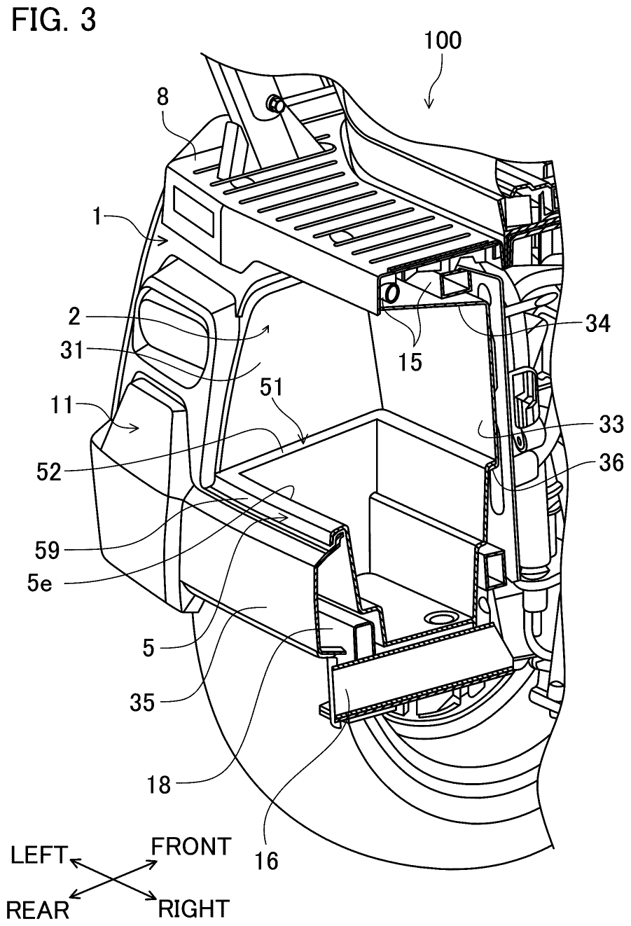

FIG. 3 is a perspective view of the vehicle body panel 11, the housing box 5, and the cargo bed 8 in a cut-off state, as seen from the right rear. The vehicle 100 further includes a first support frame 15 supporting the cargo bed 8. The vehicle 100 further includes a second support frame 16 supporting the housing box 5.

The first support frame 15 is located below the cargo bed 8 and above the housing box 5. The first support frame 15 extends in the vehicle width direction. Each end of the first support frame 15 in the vehicle width direction is coupled to, for example, another vehicle body frame. The first support frame 15 includes, for example, a metal pipe.

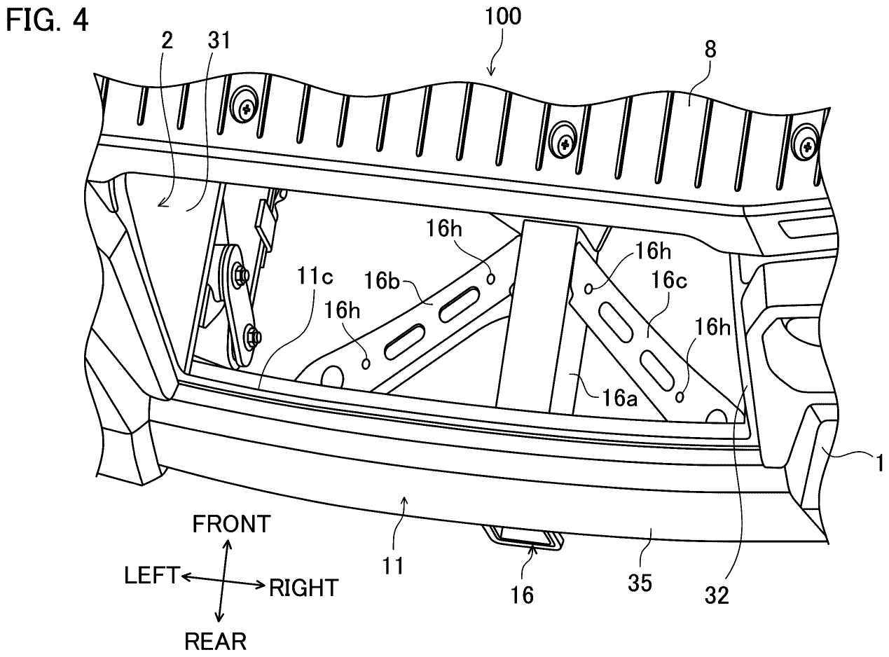

FIG. 4 is a perspective view of the vehicle rear portion from which the housing box 5 is removed, as seen from above. The second support frame 16 is located below the housing box 5 illustrated in FIG. 3. The second support frame 16 includes a first frame 16a, a second frame 16b, and a third frame 16c. The first frame 16a is located substantially at the center in the vehicle width direction and extends in the front-rear direction. The front end of the first frame 16a is coupled to, for example, another vehicle body frame. The rear end of the first frame 16a is exposed toward the rear of the vehicle body 1. The first frame 16a includes, for example, a metal square pipe. The second frame 16b is located at the left of the first frame 16a. The second frame 16b extends substantially linearly to be located rearward toward the outer side in the vehicle width direction. The front end of the second frame 16b is coupled to a front portion of the first frame 16a. The rear end of the second frame 16b is coupled to, for example, another vehicle body frame. The second frame 16b includes two screw holes 16h. The third frame 16c is located at the right of the first frame 16a. The third frame 16c extends substantially linearly to be located rearward toward the outer side in the vehicle width direction. The front end of the third frame 16c is coupled to a front portion of the first frame 16a. The rear end of the third frame 16c is coupled to, for example, another vehicle body frame. The third frame 16c includes two screw holes 16h. Each of the second frame 16b and the third frame 16c includes, for example, a metal plate.

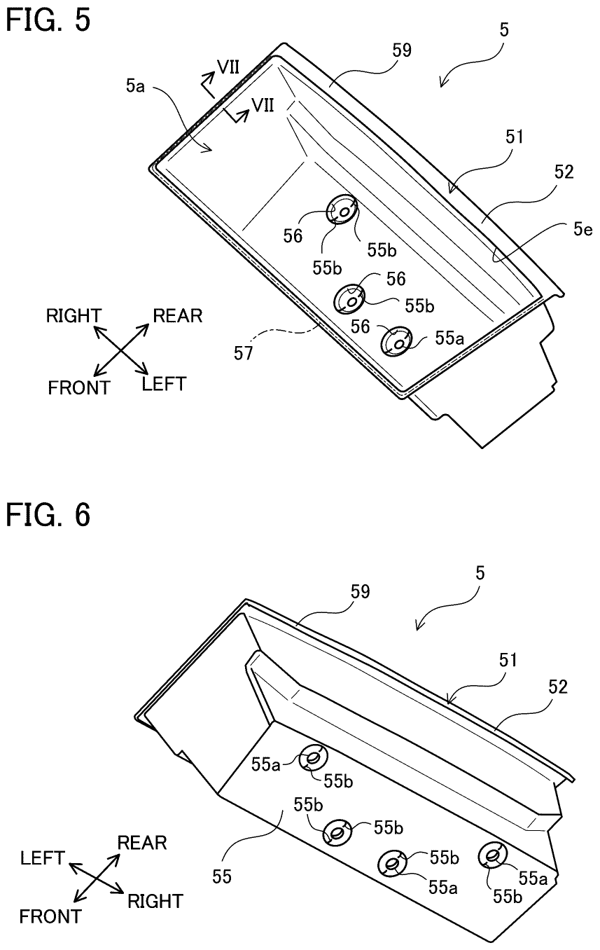

FIG. 5 is a perspective view of the housing box as seen from obliquely above. FIG. 6 is a perspective view of the housing box as seen from obliquely below.

The housing box 5 houses, for example, baggage. The housing box 5 has a box shape including a housing space therein. The entire shape of the housing box 5 is a substantially rectangular parallelepiped. The housing box 5 includes an opening 5a in the upper end. An occupant loads and unloads baggage to the housing box 5 through the opening 5a. The housing box 5 is located immediately under the cargo bed 8 illustrated in in FIG. 2.

The housing box 5 includes an opening edge portion 51 defining the opening 5a. In this embodiment, the opening edge portion 51 has an annular shape surrounding the opening 5a. The opening edge portion 51 includes a flange 52 expanding outward from the opening 5a. The flange 52 expands outward from an opening edge 5e of the opening 5a. The flange 52 has a plate shape expanding substantially horizontally.

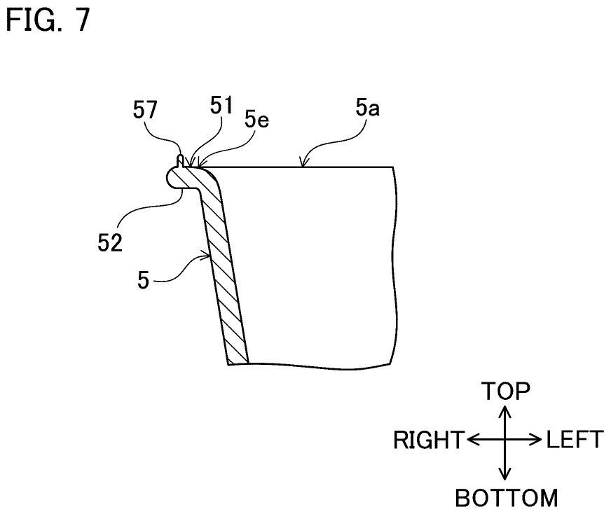

FIG. 7 is a cross-sectional view taken along line VII-VII in FIG. 5. The housing box 5 further includes a projecting wall 57 that projects upward from the flange 52. The projecting wall 57 extends along the opening edge 5e of the opening 5a. In FIG. 5, the projecting wall 57 is indicated by chain lines for convenience of description. In FIGS. 2, 3, and 4 and FIGS. 8 and 9 described later, the projecting wall 57 is not shown for convenience of description. In this embodiment, the projecting wall 57 is located on a portion of the flange 52 facing a side wall 2 described later. Specifically, the projecting wall 57 is located on a portion of the flange 52 extending rightward from the opening edge 5e, a portion of the flange 52 extending leftward from the opening edge 5e, and a portion of the flange 52 extending forward from the opening edge 5e. The projecting wall 57 is not located on a portion extending rearward from the opening edge 5e.

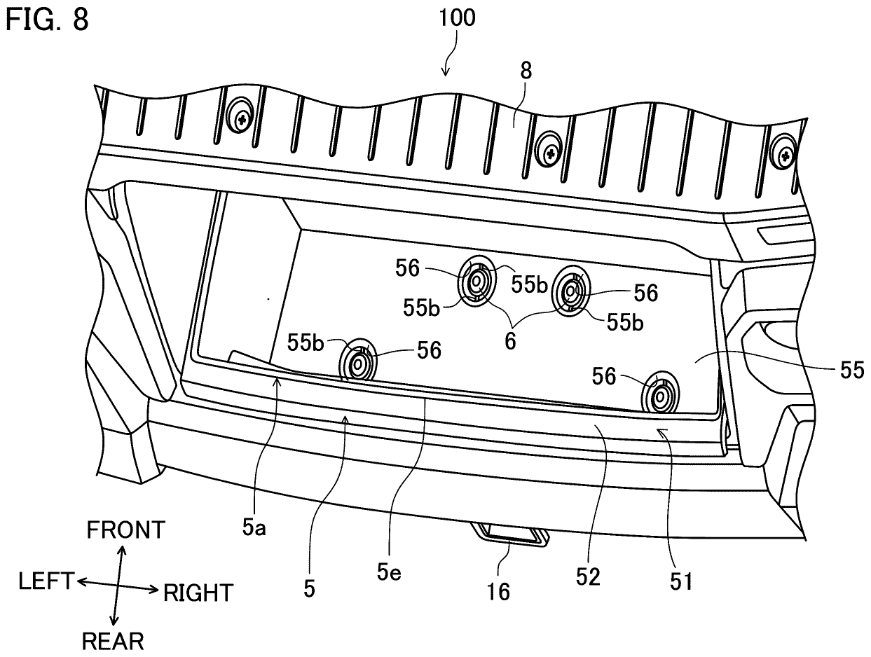

FIG. 8 is a perspective view of the vehicle rear portion as seen from obliquely above. The housing box 5 includes a bottom plate 55. The bottom plate 55 expands generally in the front-rear direction and the vehicle width direction. The bottom plate 55 has recesses 56 with drain holes 55b. In this embodiment, the bottom plate 55 has four recesses 56. Each of the recesses 56 corresponds to one of the four screw holes 16b: two screw holes 16h in the second frame 16b and the two screw holes 16h in the third frame 16c. The screw holes 16h are illustrated in FIG. 4. Each recess 56 is depressed downward from the upper surface of the bottom plate 55. The drain holes 55b discharge water that has entered the housing box 5 from the housing box 5. The drain holes 55b penetrate the bottom plate 55. In this embodiment, the bottom plate 55 includes two drain holes 55b in one recess 56. Each of the drain holes 55b has a slit.

As illustrated in FIG. 3, the vehicle body panel 11 is a panel mainly serving as an exterior of the vehicle body 1. The vehicle body panel 11 has the side wall 2 extending from a position higher than a position of the opening edge portion 51 to a position lower than the position of the opening edge portion 51. The side wall 2 is located adjacent to the housing box 5 in the horizontal direction. In this embodiment, the side wall 2 is located immediately under the cargo bed 8.

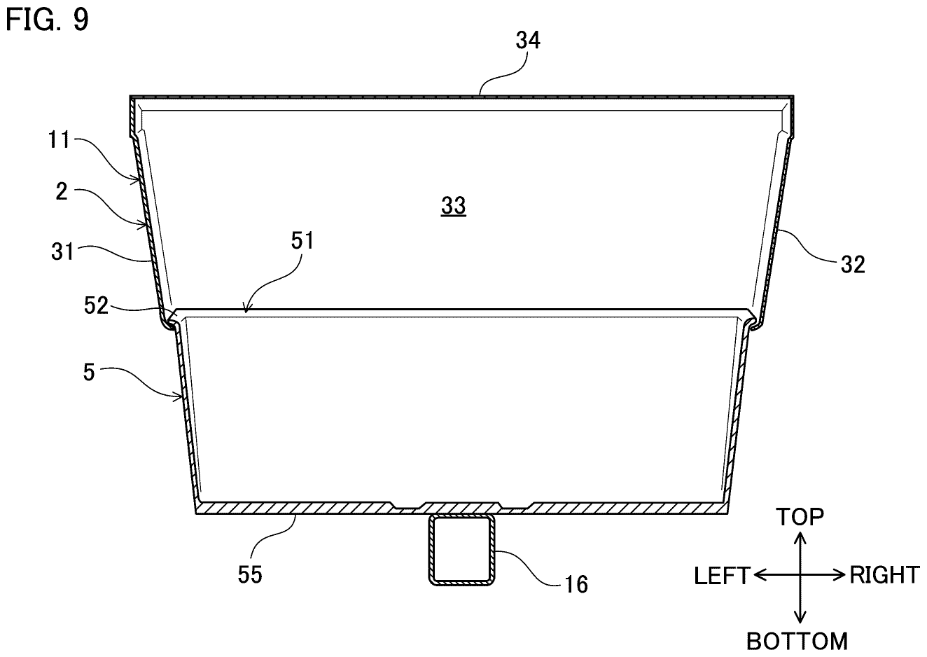

FIG. 9 is a view of the vehicle body panel 11, the housing box 5, and the second support frame 16 taken along a plane orthogonal to the front-rear direction, as seen from the rear. The side wall 2 has a plate shape. The side wall 2 expands generally in the top-bottom direction. The side wall 2 includes a first side wall 31 located at the left of the housing box 5, a second side wall 32 located at the right of the housing box 5, and a third side wall 33 located forward of the housing box 5.

The first side wall 31 expands generally in the top-bottom direction and the front-rear direction. The first side wall 31 tilts with respect to the top-bottom direction to be positioned further outward in the vehicle width direction as extending upward. The second side wall 32 expands generally in the top-bottom direction and the front-rear direction. The second side wall 32 tilts with respect to the top-bottom direction to be positioned further outward in the vehicle width direction as extending upward. The third side wall 33 expands generally in the top-bottom direction and the vehicle width direction. In this embodiment, the third side wall 33 stands upright. The third side wall 33 is coupled to each of the front edge of the first side wall 31 and the front edge of the second side wall 32.

The first side wall 31, the second side wall 32, and the third side wall 33 are made of a one piece member. The first side wall 31, the second side wall 32, and the third side wall 33 are not formed by coupling separate walls but are formed integrally.

As illustrated in FIG. 4, the vehicle body panel 11 includes an opening 11c defined by the first side wall 31, the second side wall 32, and the third side wall 33. In this embodiment, the opening 11c penetrates the vehicle body panel 11 in the top-bottom direction. The housing box 5 described above and illustrated in FIG. 2 is located in the opening 11c.

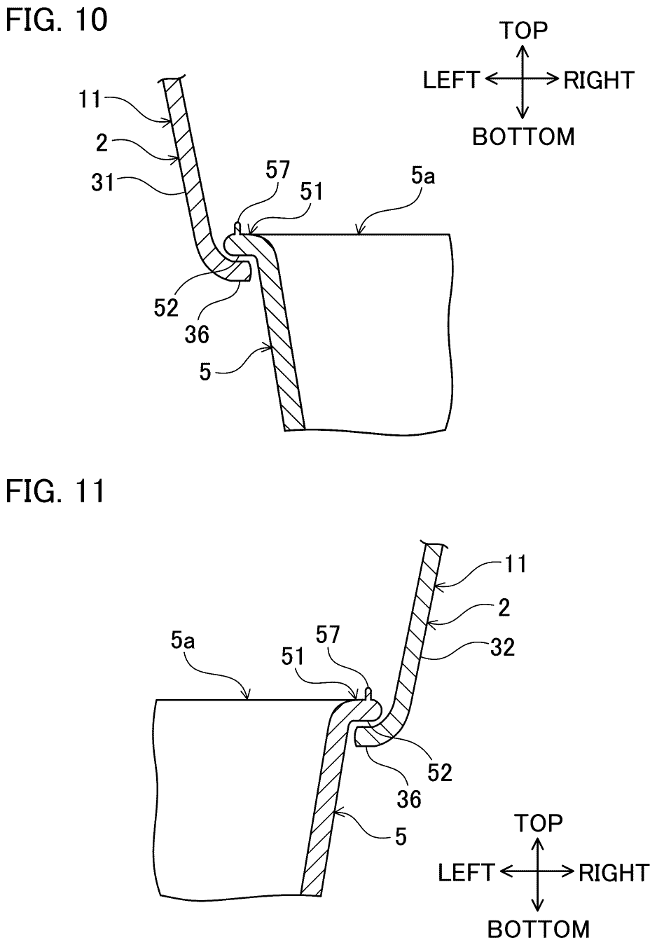

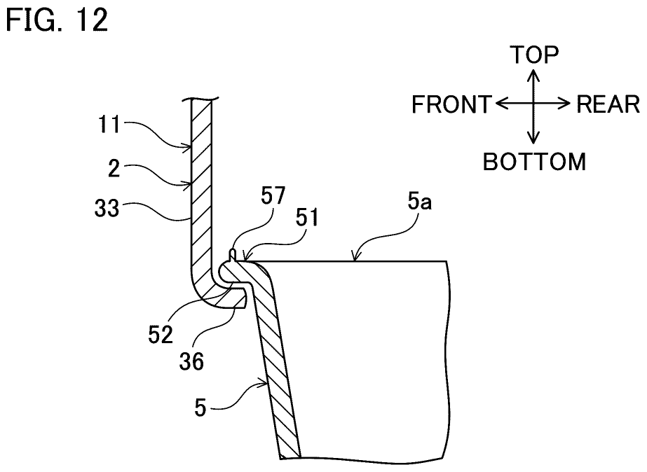

FIG. 10 is a cross-sectional view of a lower portion of the first side wall 31 and an upper portion of the housing box 5. Specifically, FIG. 10 is a cross-sectional view of the lower portion of the first side wall 31 and the upper portion of the housing box 5 taken along a plane orthogonal to the front-rear direction. FIG. 11 is a cross-sectional view of a lower portion of the second side wall 32 and the upper portion of the housing box 5. Specifically, FIG. 11 is a cross-sectional view of the lower portion of the second side wall 32 and the upper portion of the housing box 5 taken along a plane orthogonal to the front-rear direction. FIG. 12 is a cross-sectional view of a lower portion of the third side wall 33 and the upper portion of the housing box 5. Specifically, FIG. 12 is a cross-sectional view of the lower portion of the third side wall 33 and the upper portion of the housing box 5 taken along a plane orthogonal to the vehicle width direction.

The vehicle body panel 11 further includes a lower wall 36 located at a position lower than a position of the opening edge portion 51. The lower wall 36 is located below the flange 52 and faces the flange 52. In this embodiment, the lower wall 36 is separated from the housing box 5. The lower wall 36 is separated from the housing box 5 in the top-bottom direction and in the horizontal direction. The lower wall 36 is separated from the flange 52 of the housing box 5 in the top-bottom direction and in the horizontal direction. In this embodiment, the lower wall 36 extends from the side wall 2. The lower wall 36 extends from each of the first side wall 31, the second side wall 32, and the third side wall 33. The lower wall 36 extends from the lower edge of the side wall 2 toward the housing box 5. The lower wall 36 expands generally in the horizontal direction.

FIG. 13 is a perspective view of the vehicle rear portion as seen from right below. The vehicle body panel 11 further includes a top wall 34 located above the housing box 5. The top wall 34 is coupled to the first side wall 31, the second side wall 32, and the third side wall 33. As illustrated in FIG. 3, the top wall 34 covers the first support frame 15 from below. The top wall 34 overlaps with the entire first support frame 15 as seen from below. The top wall 34 has a plate shape. The top wall 34 tilts with respect to the horizontal direction to be positioned further upward as extending rearward. The top wall 34, the first side wall 31, the second side wall 32, and the third side wall 33 are made of a one piece member. The top wall 34, the first side wall 31, the second side wall 32, and the third side wall 33 are not formed by coupling separate walls but are formed integrally.

The vehicle body panel 11 further includes a rear wall 35 located at the rear end of the vehicle body 1. The rear wall 35 covers at least a portion of a rear surface of a rear bumper beam 18. The rear bumper beam 18 is a member for reducing an impact from the rear. The rear bumper beam 18 extends in the vehicle width direction. The rear bumper beam 18 is connected to the second support frame 16. The rear wall 35 expands generally in the vehicle width direction and the top-bottom direction. An upper portion of the rear wall 35 tilts with respect to the top-bottom direction to be located further forward toward the top. The rear wall 35 is coupled to each of the first side wall 31 and the second side wall 32. In this embodiment, the first side wall 31, the second side wall 32, the third side wall 33, and the rear wall 35 are made of a one piece member. The first side wall 31, the second side wall 32, the third side wall 33, and the rear wall 35 are not formed by coupling separate walls but are formed integrally. The rear wall 35 defines the opening 11c of the vehicle body panel 11 as illustrated in FIG. 4, together with the first side wall 31, the second side wall 32, and the third side wall 33.

The flange 52 described above covers the upper edge of the rear wall 35 from above. The flange 52 also covers the upper edge of the rear wall 35 from the rear. A rear flange 59 as a portion of the flange 52 extending rearward from the opening edge 5e extends rearward from the opening edge 5e and bend to extend downward. The upper edge of the rear wall 35 is located in the space surrounded by the rear flange 59.

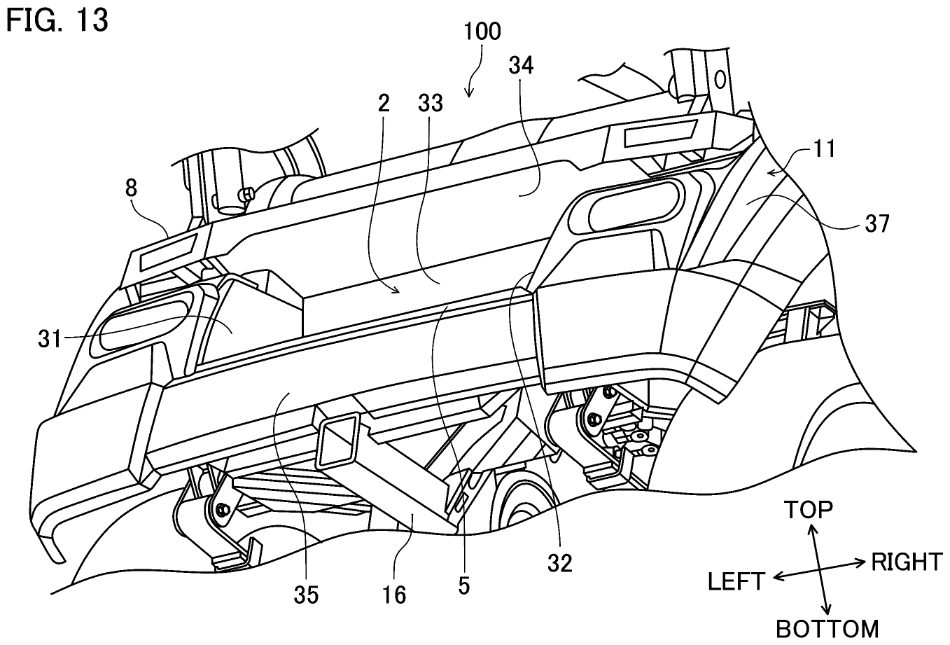

Next, an attachment structure for attaching the housing box 5 to the second support frame 16 will be described. FIG. 14 is a perspective view of the bottom plate 55 and the second support frame 16 cut off at a position of the recess 56 in the housing box 5 as seen from obliquely above.

The vehicle 100 further includes fasteners 6 that fix the housing box 5 to the second support frame 16. In this embodiment, the fasteners 6 include screws. Each of the fasteners 6 is attached to a portion of the corresponding recess 56 where the drain hole 55b is not located. A through hole 55a penetrating the bottom plate 55 is located substantially at the center of the bottom surface of each of the recesses 56. Each fastener 6 is inserted in the corresponding through hole 55a. Each fastener 6 is located on the bottom surface of the recess 56 where the drain hole 55b is not located. The fastener 6 does not overlap with the drain hole 55b in a plan view. The fasteners 6 inserted in the through holes 55a are fastened to the screw holes 16h located in the second support frame 16. In the state where the fasteners 6 are fastened to the screw holes 16h, the fasteners 6 do not close the drain holes 55b. The fasteners 6 may partially overlap with the drain holes 55b in a plan view. As illustrated in FIG. 8, in each of the four recesses 56, the fasteners 6 are fastened to the screw holes 16h. The fasteners 6 detachably attach the housing box 5 to the second support frame 16.

As illustrated in FIG. 10, the flange 52 is separated from the vehicle body panel 11. The flange 52 is separated from the side wall 2 in the horizontal direction. In this embodiment, the flange 52 is separated from the vehicle body panel 11 across the entire portion of the flange 52 facing the vehicle body panel 11. The flange 52 is separated from the first side wall 31, the second side wall 32, and the third side wall 33 in the horizontal direction. Since the flange 52 is separated from the side wall 2 in the horizontal direction, water such as rainwater flowing along the side wall 2 can flow into a gap between the flange 52 and the side wall 2. Accordingly, the amount of water entering the housing box 5 is reduced. In this embodiment, the attachment structure described above separates the flange 52 from the lower wall 36 in the top-bottom direction. The lower wall 36 is also separated from the housing box 5 in the horizontal direction. Since the lower wall 36 is separated from the flange 52 in the top-bottom direction and also separated from the housing box 5 in the horizontal direction, water that has entered the gap between the flange 52 and the side wall 2 is discharged to the outside of the housing box 5 through the gap between the lower wall 36 and the housing box 5. This further ensures reduction of the amount of water entering the housing box 5.

The flange 52 blocks splashes of water and the like scattering upward from below, and thus, entering of water splashes and the like into the housing box 5 is suppressed. The lower wall 36 is located below the flange 52 and faces the flange 52. Since the lower wall 36 blocks water splashes and the like scattering upward from below, entering of water splashes and the like into the housing box 5 is further suppressed. In this embodiment, the lower wall 36 extends from each of the first side wall 31, the second side wall 32, and the third side wall 33, is located below the flange 52, and faces the flange 52. This further ensures block of water splashes and the like scattering upward from below.

Since the housing box 5 includes the projecting wall 57 projecting upward from the flange 52, even in a case where water such as rainwater flowing along the vehicle body panel 11 flows on the flange 52, the projecting wall 57 suppresses entering of water into the housing box 5. This further reduces the amount of water entering the housing box 5.

In this embodiment, the flange 52 covers the upper edge of the rear wall 35 from above. Accordingly, baggage is less likely to get caught in the gap between the rear wall 35 and the housing box 5 when an occupant places the baggage into the housing box 5. The flange 52 also covers the upper edge of the rear wall 35 from the rear, thus further ensuring reduction of the possibility of baggage getting caught in the gap between the rear wall 35 and the housing box 5.

Since the first side wall 31, the second side wall 32, and the third side wall 33 are made of a one piece member and no gaps are present between the first side wall 31 and the second side wall 32 and between the second side wall 32 and the third side wall 33, a member located inward of the first side wall 31, the second side wall 32, and the third side wall 33 in the vehicle is less likely to be seen from the outside. Since the first side wall 31, the second side wall 32, the third side wall 33, and the rear wall 35 are made of a one piece member and no gaps are present between the first side wall 31 and the rear wall 35 and between the second side wall 32 and the rear wall 35, members inside the vehicle are less likely to be seen from the outside. Since the top wall 34 covers the first support frame 15 supporting the cargo bed 8 from below, the first support frame 15 is less likely to be seen from the outside.

The fasteners 6 are attached to portions of the recesses 56 of the housing box 5 where the drain holes 55b are not located, even in a case where water enters the housing box 5, water is smoothly discharged through the drain hole 55b without inhibition by the fasteners 6.

### Variations

A vehicle 200 according to a first variation, a vehicle 300 according to a second variation, and a vehicle 400 according to a third variation will be described. The following description will be directed mainly to a part of configurations of the vehicles 200, 300, and 400 according to the first through third variations different from the vehicle 100 according to this embodiment. In the vehicles 200, 300, and 400 according to the first through third variations, the same components as those of the vehicle 100 according to this embodiment are denoted by the same reference characters and will not be described below.

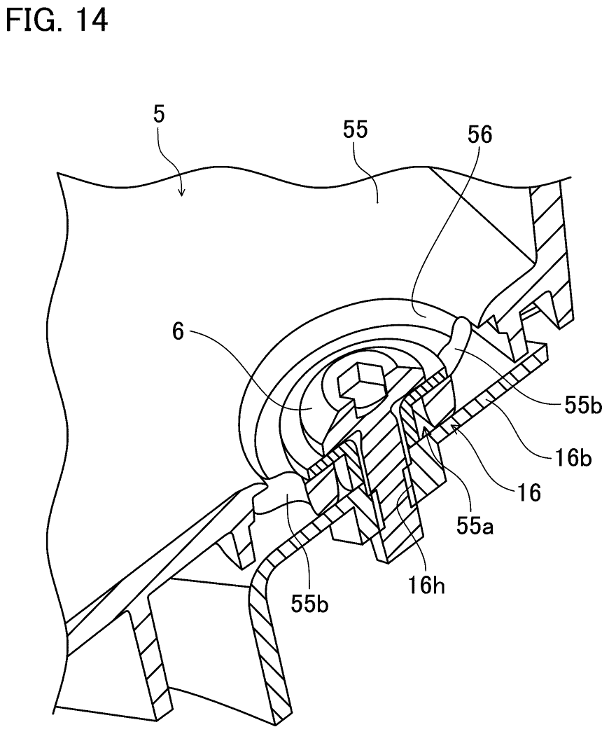

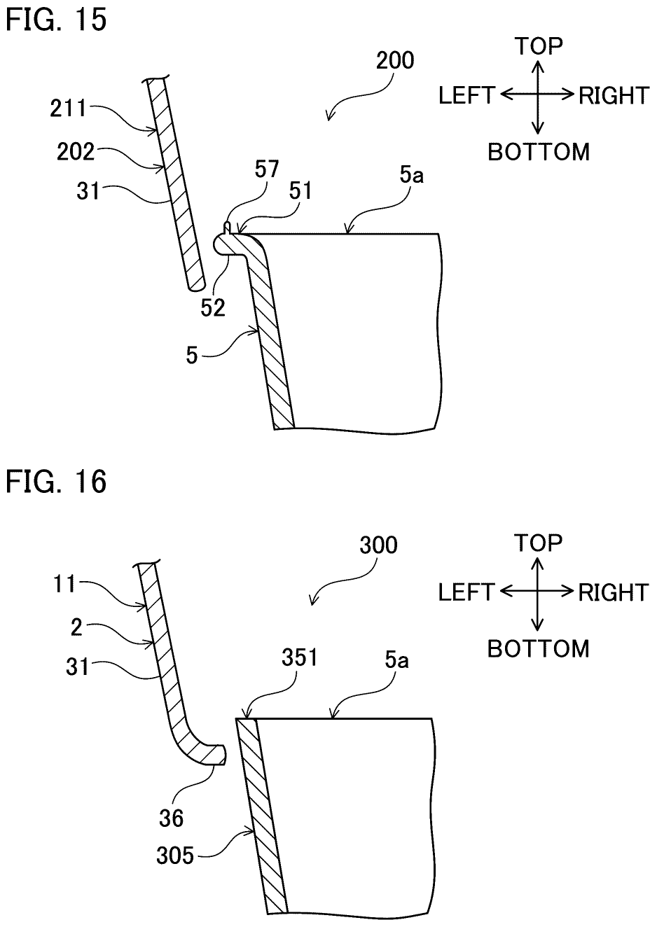

FIG. 15 is a cross-sectional view of a lower portion of a first side wall 31 and an upper portion of a housing box 5 of the vehicle 200 according to the first variation. Specifically, FIG. 15 is a cross-sectional view of the lower portion of the first side wall 31 and the upper portion of the housing box 5 taken along a plane orthogonal to the front-rear direction. The vehicle 200 is different from the vehicle 100 in the shape of a vehicle body panel 211.

In the vehicle 200, the vehicle body panel 211 includes no lower wall. An opening edge portion 51 is separated from a side wall 2.

In the vehicle 200, water such as rainwater flowing along the side wall 2 is discharged to the outside of the housing box 5 through a gap between the side wall 2 and the opening edge portion 51. Accordingly, the amount of water entering the housing box 5 is reduced.

FIG. 16 is a cross-sectional view of a lower portion of a first side wall 31 and an upper portion of a housing box 305 of the vehicle 300 according to the second variation. Specifically, FIG. 16 is a cross-sectional view of the lower portion of the first side wall 31 and the upper portion of the housing box 305 taken along a plane orthogonal to the front-rear direction. The vehicle 300 is different from the vehicle 100 in the shape of an opening edge portion 351 of the housing box 305.

In the vehicle 300, the opening edge portion 351 includes no flange. The opening edge portion 351 is separated from the side wall 2. The housing box 5 is separated from a lower wall 36 of a vehicle body panel 11.

In the vehicle 300, since the opening edge portion 351 is separated from the side wall 2, water such as rainwater flowing along the side wall 2 flows in a gap between the opening edge portion 351 and the side wall 2. That is, water such as rainwater flows outside the housing box 5. This can reduce the amount of water entering the housing box 5. In the vehicle 300, since the housing box 5 is separated from the lower wall 36, water flowing in the gap between the opening edge portion 351 and the side wall 2 is discharged to the outside of the housing box 5 through the gap between the housing box 5 and the lower wall 36. This further ensures reduction of the amount of water entering the housing box 5.

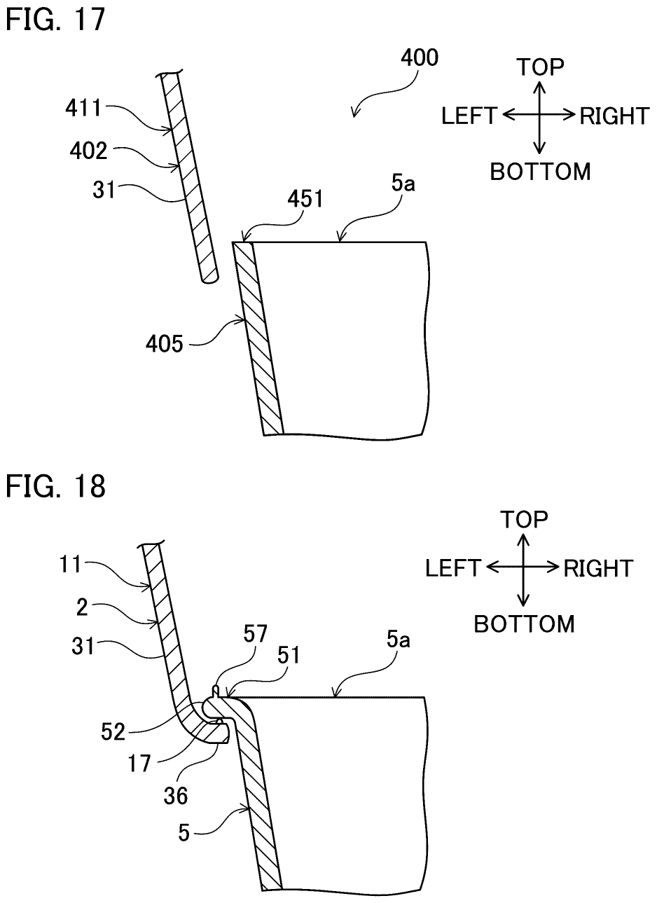

FIG. 17 is a cross-sectional view of a lower portion of a first side wall 31 and an upper portion of a housing box 405 of the vehicle 400 according to the third variation. Specifically, FIG. 17 is a cross-sectional view of the lower portion of the first side wall 31 and the upper portion of the housing box 405 taken along a plane orthogonal to the front-rear direction. The vehicle 400 is different from the vehicle 100 in the shape of a vehicle body panel 411 and the shape of an opening edge portion 451 of a housing box 405.

In the vehicle 400, in a manner similar to the vehicle body panel 211 of the first variation, the vehicle body panel 411 includes no lower wall. The opening edge portion 451 includes no flange in a manner similar to the opening edge portion 351 of the second variation. The opening edge portion 451 is separated from a side wall 2.

In the vehicle 400, water such as rainwater flowing along the side wall 2 is discharged to the outside of a housing box 405 through a gap between the side wall 2 and the opening edge portion 451. This can reduce the amount of water entering the housing box 405.

### Other Embodiments

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

The vehicle 100 may be a single-passenger vehicle. The vehicle 100 may be a vehicle with a single row of seats or a vehicle with three rows of seats. The vehicle 100 may also be a three-wheeled vehicle having three wheels, or may be a six-wheeled vehicle having six wheels. The vehicle 100 may further include a lid covering the opening 5a of the housing box 5.

The configuration of the vehicle body panel 11 is not limited to the configuration described above. For example, the lower wall 36 does not need to extend from the lower edge of the side wall 2 toward the housing box 5. Specifically, the lower wall 36 may extend from a portion of the side wall 2 located above the lower edge toward the housing box 5. The lower wall 36 may not extend toward the housing box 5 from each of the first side wall 31, the second side wall 32, and the third side wall 33. For example, the lower wall 36 may extend toward the housing box 5 from any one or two of the first side wall 31, the second side wall 32, and the third side wall 33. The lower wall 36 may not be separated from the housing box 5. For example, the upper surface of the lower wall 36 may contact the lower surface of the flange 52, or the front end of the lower wall 36 may contact a portion of the housing box 5 located below the flange 52. Even in a case where the lower wall 36 is not separated from the housing box 5, water such as rainwater flowing along the side wall 2 flows into the gap between the side wall 2 and the flange 52, and thus, the amount of water entering the housing box 5 is reduced.

The first side wall 31, the second side wall 32, and the third side wall 33 may not be made of a one piece member. The first side wall 31, the second side wall 32, and the third side wall 33 may be formed by coupling separate walls. The first side wall 31, the second side wall 32, the third side wall 33, and the rear wall 35 may not be made of a one piece member. The first side wall 31, the second side wall 32, the third side wall 33, and the rear wall 35 may be formed by coupling separate walls.

As illustrated in FIGS. 2 and 13, the vehicle body panel 11 may further include an outer wall 37 exposed to the outside of the vehicle body 1. At least a portion of the outer wall 37 may be located outside the cargo bed 8 in a plan view. Since at least a portion of the outer wall 37 is located outside the cargo bed 8 in a plan view, water such as rainwater that has flowed in the outer wall 37 from the cargo bed 8 is discharged to the outside of the vehicle body 1. This can further reduce water entering the housing box 5.

The configuration of the housing box 5 is not limited to the configuration described above. The entire opening edge portion 51 may not be separated from the vehicle body panel 11. It is sufficient that at least a part of the opening edge portion 51 is separated from the vehicle body panel 11. For example, only a part of the opening edge portion 51 may be separated from the vehicle body panel 11 in the circumferential direction of the opening edge 5e. The flange 52 may not cover the upper edge of the rear wall 35 from above. The flange 52 may not cover the upper edge of the rear wall 35 from rear. The opening edge portion 51 may not include the projecting wall 57. The housing box 5 may not include drain holes 55b. The housing box 5 may be located in a front portion of the vehicle body 1. The housing box 5 may constitute a portion of the vehicle body 1 so that the housing box 5 cannot be detached without a tool.

A method for separating the flange 52 from the lower wall 36 in the top-bottom direction is not limited to the method in which the housing box 5 is supported by the second support frame 16. For example, as illustrated in FIG. 18, the vehicle body panel 11 further includes a bump 17 projecting upward from the lower wall 36, and the flange 52 of the housing box 5 may be supported by the bump 17. FIG. 18 is a cross-sectional view of a lower portion of the first side wall 31 and an upper portion of the housing box 5 and describing another method for separating the flange 52 from the lower wall 36 in the top-bottom direction. The bump 17 is in contact with the flange 52, and thus, the opening edge portion 51 is partially separated from the vehicle body panel 11.

As illustrated in FIG. 2, the housing box 5 may be located between left and right wheels 95 in the vehicle width direction. As illustrated in FIG. 1, the position of the upper end of the housing box 5 in the top-bottom direction may be lower than the position of the upper end of a wheel well 98 in the top-bottom direction. The position of the upper end of the housing box 5 in the top-bottom direction may be lower than the position of the upper end of the wheels 95 in the top-bottom direction. The lower end of the housing box 5 in the top-bottom direction may be lower than the upper end of the wheel well 98 in the top-bottom direction. The position of the lower end of the housing box 5 in the top-bottom direction may be lower than the position of the upper end of the wheels 95 in the top-bottom direction.

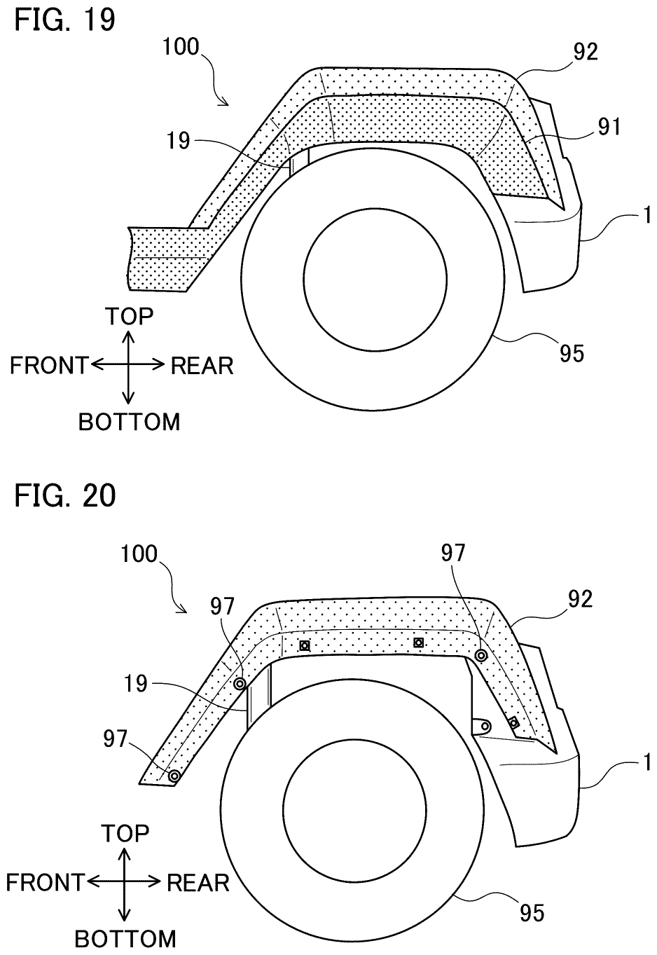

FIG. 19 is a side view of a vehicle rear portion as seen from the left. FIG. 20 is a side view of a vehicle rear portion from which the rear fender 91 is removed, as seen from the left. In FIGS. 19 and 20, small dots are used for the rear fender 91 and coarse dots are used for a rear flap 92 for convenience of description. The vehicle 100 may further include the rear fender 91 covering the wheels 95 from above, and the rear flap 92 that attaches the rear fender 91 to the vehicle body 1. The rear flap 92 is detachably attached to the vehicle body frame 19 with, for example, bolts. The rear fender 91 is detachably attached to the rear flap 92 through, for example, a grommet 97.

A vehicle according to the presence disclosure may include an off-road vehicle or may include an on-road vehicle. Examples of the off-road vehicle may include an all terrain vehicle (ATV) and a tractor. The vehicle according to the present disclosure may include a vehicle driven by an electric motor and may include a vehicle driven by an internal combustion engine.

### Aspects

The embodiment described above are a specific example of the following aspects.

### Aspect 1

A vehicle (utility vehicle 100, 200, 300, 400) includes: a vehicle body panel 11, 211, 411; a housing box 5, 305, 405 that includes an opening facing upward and is located adjacent to the vehicle body panel 11, 211, 411, the housing box 5, 305, 405 includes an opening edge portion 51, 351, 451 defining the opening 5a, and at least a part of the opening edge portion 51, 351, 451 is separated from the vehicle body panel 11, 211, 411.

In the configuration of Aspect 1, since at least a part of the opening edge portion 51, 351, 451 is separated from the vehicle body panel 11, 211, 411, water such as rainwater flowing along the vehicle body panel 11, 211, 411 passes through a gap between at least the part of the opening edge portion 51, 351, 451 and the vehicle body panel 11, 211, 411. Water such as rainwater flows outside the housing box 5, 305, 405, and thus, the amount of water entering the housing box 5, 305, 405 is reduced.

### Aspect 2

In the vehicle of Aspect 1, the opening edge portion 51 includes a flange 52 expanding outward from the opening 5a.

In the configuration of Aspect 2, the flange 52 blocks splashes of water and the like scattering upward from below, and thus, entering of water splashes and the like into the housing box 5 is suppressed.

### Aspect 3

In the vehicle of Aspect 1 or Aspect 2, the flange 52 is separated from the vehicle body panel 11, 211, 411 across an entire portion of the flange facing the vehicle body panel 11, 211, 411.

The configuration of Aspect 3 can further reduce the amount of water entering the housing box 5.

### Aspect 4

In the vehicle of any one of Aspects 1 to 3, the vehicle body panel 11 includes a lower wall 36 located at a position lower than a position of the opening edge portion 51, 351, and the lower wall 36 is located below the flange 52 and faces the flange 52.

In the configuration of Aspect 4, the housing box 5 blocks splashes of water and the like scattering upward from below, and thus, entering of water splashes and the like into the housing box 5 is suppressed.

### Aspect 5

In the vehicle of any one of Aspects 1 to 4, the vehicle body panel 11 includes a side wall 2 extending from a position higher than the position of the opening edge portion 51, 351 to a position lower than the position of the opening edge portion 51, 351, and the lower wall 36 extends from the side wall 2.

In the configuration of Aspect 5, the lower wall 36 extends from the side wall 2, is located below the flange 52, and faces the flange 52. Thus, no gap is present between the vehicle body panel 11 and the housing box 5 when the vehicle body panel 11 and the housing box 5 are seen from below. This further ensures block of water splashes and the like scattering upward from below, and entering of the water splashes and the like into the housing box 5 is further suppressed.

### Aspect 6

In the vehicle of any one of Aspects 1 to 5, the housing box 5, 305, 405 is located in a rear portion of a vehicle body 1, the vehicle body panel 11, 211, 411 includes a rear wall 35 located at a rear end of the vehicle body 1, and the flange 52 covers an upper edge of the rear wall 35 from above.

In the configuration of Aspect 6, baggage is less likely to get caught in a gap between the rear wall 35 and the housing box 5, 305, 405 when an occupant places the baggage into the housing box 5, 305, 405, for example.

### Aspect 7

In the vehicle of any one of Aspects 1 to 6, the flange 52 covers the upper edge of the rear wall 35 from rear.

The configuration of Aspect 7 further ensures the possibility of baggage getting caught in the gap between the rear wall 35 and the housing box 5, 305, 405.

### Aspect 8

In the vehicle of any one of Aspects 1 to 7, the housing box 5, 305, 405 is located in a rear portion of a vehicle body 1, the vehicle body panel 11, 211, 411 includes a side wall 2, 202, 402 extending from a position higher than a position of the opening edge portion 51, 351, 451 to a position lower than the position of the opening edge portion 51, 351, 451, and the side wall 2, 202, 402 includes a first side wall 31 located leftward of the housing box 5, 305, 405, a second side wall 32 located rightward of the housing box 5, 305, 405, and a third side wall 33 located forward of the housing box 5, 305, 405, and the first side wall 31, the second side wall 32, and the third side wall 33 are made of a one piece member.

In the configuration of Aspect 8, since no gaps are present between the first side wall 31 and the second side wall 32 and between the second side wall 32 and the third side wall 33, a member located inward of the first side wall 31, the second side wall 32, and the third side wall 33 in the vehicle is less likely to be seen from the outside.

### Aspect 9

In the vehicle of any one of Aspects 1 to 8, the vehicle body panel 11 includes a lower wall 36 located at a position lower than the position of the opening edge portion 51, 351, and the lower wall 36 extends from each of the first side wall 31, the second side wall 32, and the third side wall 33, is located below the flange 52, and faces the flange 52.

The configuration of Aspect 9 further ensures block of water splashes and the like scattering upward from below.

### Aspect 10

In the vehicle of any one of Aspects 1 to 9, the vehicle body panel 11, 211, 411 further includes a rear wall 35 located at a rear end of the vehicle body 1, and the first side wall 31, the second side wall 32, the third side wall 33, and the rear wall 35 are made of a one piece member.

In the configuration of Aspect 10, since no gaps are present between the first side wall 31 and the rear wall 35 and between the second side wall 32 and the rear wall 35, a member located inward of the vehicle is much less likely to be seen from the outside.

### Aspect 11

In the vehicle of any one of Aspects 1 to 10, the vehicle body panel 11, 211, 411 includes an opening 11c defined by the first side wall 31, the second side wall 32, and the third side wall 33, and the housing box 5, 305, 405 is located in the opening 11c defined by the first side wall 31, the second side wall 32, and the third side wall 33.

In the configuration of Aspect 11, in placing the housing box 5, 305, 405 on the vehicle body panel 11, 211, 411, the housing box 5, 305, 405 is guided to a placement position by the first side wall 31, the second side wall 32, and the third side wall 33. Thus, the housing box 5, 305, 405 can be easily placed on the vehicle body panel 11, 211, 411.

### Aspect 12

The vehicle of any one of Aspects 1 to 11 further includes: a cargo bed 8 located above the housing box 5, 305, 405; and a first support frame 15 located below the cargo bed 8 and above the housing box 5, 305, 405 and supporting the cargo bed 8, and the vehicle body panel 11, 211, 411 further includes a top wall 34 located above the housing box 5, 305, 405, coupled to the first side wall 31, the second side wall 32, and the third side wall 33, and covering the first support frame 15 from below.

In the configuration of Aspect 12, the first support frame 15 is less likely to be seen from the outside.

### Aspect 13

In the vehicle of any one of Aspects 1 to 12, the opening edge portion 51 further includes a projecting wall 57 projecting upward from the flange 52 and extending along an opening edge 5e of the opening 5a.

In the configuration of Aspect 13, even in a case where water such as rainwater flowing along the vehicle body panel 11, 211 on the flange 52, the projecting wall 57 prevents water from entering the housing box 5. This further reduces the amount of water entering the housing box 5.

### Aspect 14

In the vehicle of any one of Aspects 1 to 13, the vehicle body panel 11, 211, 411 includes a side wall 2, 202, 402 extending from a position higher than a position of the opening edge portion 51, 351, 451 to a position lower than the position of the opening edge portion 51, 351, 451, and at least a part of the opening edge portion 51, 351, 451 is separated from the side wall 2, 202, 402.

In the configuration of Aspect 14, since at least a part of the opening edge portion 51, 351, 451 is separated from the side wall 2, 202, 402, water such as rainwater flowing along the side wall 2, 202, 402 passes through a gap between at least a part of the opening edge portion 51, 351, 451 and the side wall 2, 202, 402. That is, water such as rainwater flows outside the housing box 5, 305, 405, and thus, the amount of water entering the housing box 5, 305, 405 is reduced.

### Aspect 15

In the vehicle of any one of Aspects 1 to 14, wherein the vehicle body panel 11 includes a lower wall 36 located at a position lower than the position of the opening edge portion 51, 351 and extending from the side wall 2.

In the configuration of Aspect 15, the housing box 5 blocks splashes of water and the like scattering upward from below, and thus, entering of water splashes and the like into the housing box 5 is suppressed.

### Aspect 16

In the vehicle of any one of Aspects 1 to 15, the opening edge portion 51 includes a flange 52 expanding outward from the opening 5a.

In the configuration of Aspect 16, the flange 52 blocks splashes of water and the like scattering upward from below, and thus, entering of water splashes and the like into the housing box 5 is suppressed.

### Aspect 17

The vehicle of any one of Aspects 1 to 16 further includes a second support frame 16 located below the housing box 5, 305, 405 and supporting the housing box 5, 305, 405.

The configuration of Aspect 17 can achieve a configuration in which at least a part of opening edge portion 51, 351, 451 is separated from the vehicle body panel 11, 211, 411 in the top-bottom direction.

### Aspect 18

The vehicle of any one of Aspects 1 to 17 further comprising a fastener 6 that fixes the housing box 5, 305, 405 to the second support frame 16, and the housing box 5, 305, 405 includes a bottom plate 55, the bottom plate 55 includes a recess 56 with a drain hole 55b, and the fastener 6 is attached to a portion of the recess 56 where the drain hole 55b is not located.

In the configuration of Aspect 18, even in a case where water enters the housing box 5, 305, 405, water is smoothly discharged through the drain hole 55b without inhibition by the fastener 6.

What is claimed:

1. A vehicle comprising:
a vehicle body panel; and
a housing box that includes an opening facing upward and is located adjacent to the vehicle body panel, wherein
the housing box includes an opening edge portion defining the opening, and
at least a part of the opening edge portion is separated from the vehicle body panel.

2. The vehicle according to claim 1, wherein
the opening edge portion includes a flange expanding outward from the opening.

3. The vehicle according to claim 2, wherein
the flange is separated from the vehicle body panel across an entire portion of the flange facing the vehicle body panel.

4. The vehicle according to claim 2, wherein
the vehicle body panel includes a lower wall located at a position lower than a position of the opening edge portion, and
the lower wall is located below the flange and faces the flange.

5. The vehicle according to claim 4, wherein
the vehicle body panel includes a side wall extending from a position higher than the position of the opening edge portion to a position lower than the position of the opening edge portion, and
the lower wall extends from the side wall.

6. The vehicle according to claim 2, wherein
the housing box is located in a rear portion of a vehicle body,
the vehicle body panel includes a rear wall located at a rear end of the vehicle body, and
the flange covers an upper edge of the rear wall from above.

7. The vehicle according to claim 6, wherein
the flange covers the upper edge of the rear wall from rear.

8. The vehicle according to claim 2, wherein
the housing box is located in a rear portion of a vehicle body,
the vehicle body panel includes a side wall extending from a position higher than a position of the opening edge portion to a position lower than the position of the opening edge portion,
the side wall includes a first side wall located leftward of the housing box, a second side wall located rightward of the housing box, and a third side wall located forward of the housing box, and
the first side wall, the second side wall, and the third side wall are made of a one piece member.

9. The vehicle according to claim 8, wherein
the vehicle body panel includes a lower wall located at a position lower than the position of the opening edge portion, and
the lower wall extends from each of the first side wall, the second side wall, and the third side wall, is located below the flange, and faces the flange.

10. The vehicle according to claim 8, wherein
the vehicle body panel further includes a rear wall located at a rear end of the vehicle body, and
the first side wall, the second side wall, the third side wall, and the rear wall are made of a one piece member.

11. The vehicle according to claim 8, wherein
the vehicle body panel includes an opening defined by the first side wall, the second side wall, and the third side wall, and
the housing box is located in the opening defined by the first side wall, the second side wall, and the third side wall.

12. The vehicle according to claim 8, further comprising:
a cargo bed located above the housing box; and
a first support frame located below the cargo bed and above the housing box and supporting the cargo bed, wherein
the vehicle body panel further includes a top wall located above the housing box, coupled to the first side wall, the second side wall, and the third side wall, and covering the first support frame from below.

13. The vehicle according to claim 2, wherein
the opening edge portion further includes a projecting wall projecting upward from the flange and extending along an opening edge of the opening.

14. The vehicle according to claim 1, wherein
the vehicle body panel includes a side wall extending from a position higher than a position of the opening edge portion to a position lower than the position of the opening edge portion, and
at least a part of the opening edge portion is separated from the side wall.

15. The vehicle according to claim 14, wherein
the vehicle body panel includes a lower wall located at a position lower than the position of the opening edge portion and extending from the side wall.

16. The vehicle according to claim 14, wherein
the opening edge portion includes a flange expanding outward from the opening.

17. The vehicle according to claim 1, further comprising
a second support frame located below the housing box and supporting the housing box.

18. The vehicle according to claim 17, further comprising
a fastener that fixes the housing box to the second support frame, wherein
the housing box includes a bottom plate,
the bottom plate includes a recess with a drain hole, and
the fastener is attached to a portion of the recess where the drain hole is not located.
